(19) United States
(12) Patent Application Publication
(10) Pub. No.: US 2005/0003978 A1
(43) Pub. Date: Jan. 6, 2005

(54) Quaternary ammonium carbonates and bicarbonates as anticorrosive agents

(75) Inventors: Larry K. Hall, Easton, PA (US); Joseph W. Scheblein, Hunderton, NJ (US); Michael Y. Chiang, Hunderton, NJ (US); Joseph Kimler, Yardville, NJ (US)

Correspondence Address: DARBY & DARBY P.C., P. O. BOX 5257, NEW YORK, NY, 10150-5257, US

(73) Assignee: Lonza Inc., Fair Lawn, NJ (US)

(21) Appl. No.: 10/810,279

(22) Filed: Mar. 26, 2004

Related U.S. Application Data
(60) Provisional application No. 60/474,081, filed on May 28, 2003.

(51) Int. Cl. C11D 1/00

(52) U.S. Cl. 510/175; 427/384

(57) ABSTRACT

Quaternary ammonium carbonates, bicarbonates, and mixtures thereof as anti-corrosive agents. The present disclosure relates to a method for inhibiting the corrosion of metal surfaces by applying a composition containing one or more quaternary ammonium carbonate or bicarbonate. The disclosure is also directed to anti-corrosive coatings for metal substrates containing these compounds, to metal substrates having these anticorrosive coatings, and to aqueous cleaning solutions containing these compounds.

This application claims the benefit of U.S. Provisional Application No. 60/474,081, filed May 28, 2003, which is hereby incorporated by reference.

### FIELD OF THE INVENTION

The present invention relates to the use of quaternary ammonium carbonates and bicarbonates as anticorrosive agents.

### BACKGROUND OF THE INVENTION

In processes where metal surfaces come in contact with water, whether as liquid water or humid air, there is always the danger of corrosion. This is particularly problematic when the metal itself is prone to corrosion and is not coated.

Examples of metals prone to corrosion are found in stamped metal car parts made from ferrous alloys, abraded surfaces such as machined steel parts, and machine components made from cast iron. Although corrosion inhibitors (or anticorrosive agents) have been known for many years, most are still inadequate. One key inadequacy is that of water solubility. Most corrosion inhibitors are produced from long chain fatty acids and derivatives and often have poor aqueous solubility. This is especially problematic when the metal surface contacts both water and oil, such as in oil and gas production, petroleum processing, and metal working applications. Petrochemical processing itself presents a wide array of challenges for corrosion inhibitors including cooling systems, refinery units, pipelines, steam generators, and oil or gas producing units.

In order to reduce the rate of corrosion of metals (such as metal vessels, equipment metal parts, equipment surfaces, pipelines, and equipment used to store the fluids), especially those containing iron, corrosion inhibitors are typically added to the fluid contacting the metal. The fluid may be a gas, a slurry, or a liquid.

Traditional solvents for cleaning metal and metal parts, such as mineral spirits and kerosene, have been replaced in recent years by aqueous formulations due to concerns about volatile organic carbons (VOCs). This move toward water-based formulations for cleaning metal parts is not without problems. Water does not solubilize grease or oily residues easily, and water itself can markedly increase the corrosion of the metal parts themselves. In addition, formulations are typically used as microemulsions, which require the use of additional surfactants for stabilization during the cleaning process. Morpholine is frequently used in these cleaning formulations to provide corrosion protection. However, morpholine does little to contribute to cleaning, and does not stabilize the microemulsion, since it is not a good surfactant. Furthermore, morpholine is a regulated product, since it may be used to prepare illicit drugs.

Quaternary ammonium compounds have found limited use as corrosion inhibitors. U.S. Pat. No. 6,521,028 discloses the use of particular pyridinium and quinolinium salts, in either propylene glycol or propylene glycol ether solvents, as corrosion inhibitors.

U.S. Pat. Nos. 6,080,789, and 6,297,285 disclose the use of quaternary ammonium carbonates as disinfectants.

U.S. Pat. No. 4,792,417 discloses a composition for inhibiting stress corrosion of stainless steel in contact with aqueous and/or polar organic solutions which contain chloride ions and optionally cuprous ions. The composition comprises an aqueous or polar organic solution of a particular quaternary ammonium alkylcarbonate or quaternary ammonium benzylcarbonate.

There is still a need for corrosion inhibitors that possess good affinity for metallic surfaces and are both water and oil soluble. Additionally, there is a desire for new corrosion inhibitors that add cleaning and or surfactant capability. Corrosion inhibitors that also afford antimicrobial protection to the finished formulation to which they are applied would be particularly advantageous.

### SUMMARY OF THE INVENTION

It has now been discovered that quaternary ammonium carbonates and bicarbonates inhibit the corrosion of metals.

The present invention relates to a method for inhibiting the corrosion of metal surfaces by applying (or depositing) a corrosion inhibiting effective amount of a composition comprising (a) at least one quaternary ammonium carbonate, bicarbonate, or a mixture thereof; and (b) optionally, a solvent, a surfactant, or a mixture thereof. This method is particularly useful for down-hole applications in oilfields and metal working.

Another embodiment is an anti-corrosive coating for metal substrates. The coating includes at least one quaternary ammonium carbonate, bicarbonate, or a mixture thereof, and a coating material. Typically, the quaternary ammonium carbonate, bicarbonate or a mixture thereof is dispersed in the coating material. According to a preferred embodiment, the coating also exhibits antimicrobial efficacy. The coating may include an antimicrobial effective amount of the anti-corrosive quaternary ammonium carbonate, bicarbonate, or mixture thereof or of a different antimicrobial agent.

Yet another embodiment is a metal substrate having the anticorrosive coating of the present invention on a surface thereof.

Yet another embodiment is an aqueous solution, such as an aqueous cleaning solution, comprising a corrosion inhibiting effective amount of at least one quaternary ammonium carbonate, bicarbonate, or a mixture thereof. The aqueous cleaning solution may be an aqueous-based metal cleaner.

### BRIEF DESCRIPTION OF THE DRAWINGS

FIG. 1 is a picture of cold rolled plates of steel, each in a didecyldimethylammonium chloride solution or a didecyldimethylammonium carbonate/bicarbonate solution after 90 minutes at room temperature.

FIG. 2 is a picture of cold rolled plates of steel, each in a didecyldimethylammonium chloride solution or a didecyldimethyl ammonium carbonate/bicarbonate solution after 30 days at room temperature.

FIG. 3 is a picture of cold rolled plates of steel, each in a didecyldimethylanmmonium chloride solution or a didecyldimethyl ammonium carbonate/bicarbonate solution after 9 months at room temperature. A sample of cold rolled steel in deionized water after 5 hours is also shown.

FIG. 4 is a picture of cold rolled plates of steel after soaking for 9 months at room temperature in a didecyldimethylammonium chloride solution or a didecyldimethyl ammonium carbonate/bicarbonate solution, and after soaking in deionized water for 5 hours at room temperature.

### DETAILED DESCRIPTION OF THE INVENTION

Corrosion Inhibitor Compositions

The present invention is directed towards the inhibition of corrosion of metal substrates. The term “inhibition of corrosion” as used herein includes, but is not limited to, the prevention or reduction in the rate of oxidation of a metal surface, generally when the metal is exposed to water or air, or a combination of the two. The oxidation of metal is an electrochemical reaction generally resulting either in a loss of metal from the surface or an accumulation of oxidation products at the surface of the metal. The term “metal ” as used herein includes, but is not limited to, steel, cast iron, aluminum, metal alloys, and combinations thereof. In one embodiment, the metal substrate is an aerosol can.

Quaternary ammonium carbonates useful in the present invention include, but are not limited to, those having the formula: 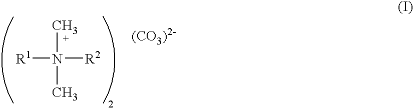
wherein R¹ and R² are each independently a C₁-C₂₀ alkyl group or an aryl-substituted C₁-C₂₀ alkyl group (e.g., a benzyl group). R¹ and R² may be the same or different.

The term “aryl-substituted alkyl group” refers to an alkyl group substituted by one or more aromatic carbon rings, such as ethyl benzyl (the alkyl group being bound to the nitrogen atom). Similarly, the term “aryl-substituted C₁-C₂₀ alkyl group” refers to a C₁-C₂₀ alkyl group substituted by one or more aromatic carbon rings.

According to one embodiment, R¹ and R² are C₄-C₂₀ alkyl or aryl-substituted C₄-C₂₀ alkyl group. According to a preferred embodiment, R¹ is a C₈-C₁₂ alkyl or aryl-substituted C₈-C₁₂ alkyl group. A more preferred quaternary ammonium carbonate is didecyldimethylammonium carbonate, such as di-N,N′-decyldimethyl ammonium carbonate.

Didecyldimethylammonium carbonate is available as a 50 percent by weight solution of active carbonate compound in water containing 4 percent or less by weight of an alcohol, such as methanol or ethanol. The solution is a yellow/orange liquid that has a slightly fruity odor.

Suitable quaternary ammonium bicarbonates include, but are not limited to, those having the formula: 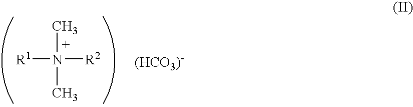
wherein R¹ and R² are defined as above. A preferred quaternary ammonium bicarbonate is didecyldimethyl ammonium bicarbonate, such as di-n-decyldimethyl ammonium bicarbonate.

The aforementioned quaternary ammonium carbonates and bicarbonates can be prepared by methods known in the art, such as those described in U.S. Pat. No. 5,438,034 and International Publication No. WO 03/006419, both of which are hereby incorporated by reference.

The quaternary ammonium carbonates and bicarbonates are in equilibrium. The concentrations of bicarbonates and carbonates vary depending on the pH of the solution in which they are contained.

The above described quaternary ammonium carbonates and bicarbonates can be used alone as corrosion inhibitors or formulated into corrosion inhibitor formulations.

Unlike traditional quaternary ammonium chlorides, the carbonate and bicarbonate based quaternary ammonium compounds described herein not only have low corrosion properties, but act as corrosion inhibitors.

The carbonates and bicarbonates are miscible in water in all concentrations, have high oil solubility, and have a high affinity for metal surfaces. In addition, the carbonates and bicarbonates increase the solubility of oils, such as fragrance oils and lipophilic substances, in aqueous solutions.

Suitable solvents for the quaternary ammonium carbonates and bicarbonates include polar solvents (such as water and water-miscible polar solvents), organic glycols, glycol ethers (such as propylene glycol) and mixtures thereof. Optionally, one or more surfactants may be included in the composition. Suitable surfactants include non-ionic surfactants, cationic surfactants, amphoteric surfactants, and mixtures thereof. Non-limiting examples of such surfactants are amine oxides, linear alcohol ethoxylates, secondary alcohol ethoxylates, ethoxylate ethers, betamines, and mixtures thereof. For example, the surfactant may be nonylphenol ethoxylate.

The quaternary ammonium carbonate and bicarbonate corrosion inhibitors inhibit corrosion of metals in aqueous and oil environments, including water and oil mixtures (e.g., in down-hole applications in oilfields and metal working). A non-limiting example of an oil found in an oil environment is a petroleum distillate. Examples of petroleum distillates include, but are not limited to, kerosene, white spirits, and hydrocarbon fractions. In metal working, aqueous solutions and water-oil mixtures are frequently used for lubrication (such as for lubricating metal working tools).

Other conventional additives, such as builders, colorants, perfumes, fragrances, cleaners, and mixtures thereof, may be included in the anticorrosive composition.

The amount of quaternary ammonium carbonates and/or bicarbonates applied to a metal substrate is a corrosion inhibiting effective amount, i.e., an amount to prevent or reduce the rate of corrosion of the metal substrate. The corrosion inhibiting effective amount may vary depending upon the use intended, and can be determined by one of ordinary skill in the art.

Without wishing to be bound by any particular theory, it is believed that in aqueous solutions, the quaternary ammonium carbonate/bicarbonate compounds described herein have a natural affinity for the metal, since they also act as cationic surfactants, and therefore migrate to the surface of the metal. Once at the surface, the quaternary ammonium carbonate/bicarbonate blocks oxygen and/or air from causing further oxidation of the metal surface.

Typically, the corrosion inhibiting composition can be supplied in either a dilutible concentrated form, or in a ready to use form. Generally, the ready to use form contains from about 0.005% to about 1.00% by weight of quaternary ammonium carbonate, bicarbonate, or mixture thereof based upon 100% by weight of the total composition. Preferably, the ready to use form contains from about 100 ppm to about 1000 ppm of quaternary ammonium carbonate, bicarbonate, or a mixture thereof, based upon the 100% by weight of total composition. Preferably, the final use dilution contains from about 100 ppm to about 500 ppm of quaternary ammonium carbonate, bicarbonate, or a mixture thereof, based upon 100% by weight of total use dilution.

The composition may be applied to the metal substrate by any means known in the art, including, but not limited to, coating, depositing, dipping, soaking, brushing, spraying, mopping, washing or the like.

Coatings

The aforementioned anti-corrosive quaternary ammonium carbonates, bicarbonates, and mixtures thereof may be incorporated into a coating for a metal substrate. The coating of the present invention typically also includes a coating material. Preferably, the quaternary ammonium carbonate, bicarbonate, or mixture thereof is dispersed in the coating material.

Suitable coating materials include, but are not limited to, organic resins, such as epoxy resin, urethane resins, vinyl resins, butyral resin, phthalic acid resin, curabale resins, such as isocyanate and butadiene resins, as well as traditional coatings, such as varnishes, low VOC solvent coatings based on polyurethanes, and water-based coatings such as rosin fatty acid vinylic emulsions. The coating may be formed by methods known in the art.

The coatings of the present invention may be, for example, paints, primers, and industrial coatings.

Additional ingredients that may be present in the coating include, but are not limited to, UV stabilizers, curing agents, hardening agents, flame retardants, and mixtures thereof.

Aqueous Solutions (Including Cleaning Solutions)

The aforementioned corrosion inhibitor compositions are particularly useful as components of aqueous cleaning solutions to retard and minimize the corrosion of metal parts, particularly steel, being cleaned with these solutions. The corrosion inhibitor compositions also afford anti-microbial protection to the substrate, such as metal, to which they are applied. For the purpose of the present invention, the term “cleaning solution” refers to an aqueous acidic or alkaline solution that is employed in the cleaning of metal surfaces, e.g., the internal metal surfaces of process equipment. These cleaning solutions typically have a pH in the range of about 1 to about 10. Exemplary cleaning solutions and their uses are disclosed in several patents, e.g., U.S. Pat. Nos. 3,413,160; 4,637,899; Re.30,796; and Re.30,714, all of which are incorporated herein by reference.

Cleaning solution compositions in accord with the present invention may include at least one organic acid selected from the group consisting of alkylene polyamine polycarboxylic acids, hydroxyacetic acid, formic acid, citric acid and mixtures or salts thereof together with a corrosion inhibitor in accord with the foregoing compositions present in an amount effective to inhibit the corrosion of metals in contact with the solution. Exemplary organic acids include N,N,N′,N′-ethylene diamine tetraacetic acid (EDTA), tetraammonium EDTA, diammonium EDTA, N-2-hydroxyethyl N,N,N′-ethylene diamine triacetic acid (HEDTA) and salts thereof. These aqueous cleaning solutions typically exhibit a pH from about 1 to about 10. Exemplary amounts of corrosion inhibitor (i.e., quaternary ammonium carbonate, bicarbonate, or a mixture thereof) are from about 0.05 to about 1 percent by weight. Exemplary organic acid cleaning solutions include those described in U.S. Pat. No. 6,521,028, which is hereby incorporated by reference.

The corrosion inhibitor compositions of the present invention may also be used in aqueous cleaning solutions to inhibit the corrosion of metal by hypochlorite as well as by inorganic acids, e.g., sulfuric acid or phosphoric acid. These cleaning solutions include an amount of corrosion inhibitor in accord with the present invention that is sufficient to inhibit the corrosion of metals by these inorganic acids. Exemplary amounts of corrosion inhibitor are from about 0.05 to about 1 percent by weight.

Corrosion inhibitors in accord with the present invention prevent, or at least minimize, excess corrosion of clean base metal during chemical cleaning operations. The corrosion inhibitor compositions may be employed advantageously over a wide pH range in a wide number of cleaning solutions employing an organic acid as the cleaning agent.

Cleaning solutions are frequently employed in the removal of scale and rust from ferrous metals. However, the solutions often contact other metals that are present as an integral part of the system being cleaned. Examples of those metals include copper, copper alloys, zinc, zinc alloys and the like.

The corrosion inhibitor compositions of the present invention advantageously are employed in an amount sufficient to inhibit acid-induced corrosion of metals that are in contact or contacted with aqueous cleaning solutions. According to one embodiment, the corrosion inhibitor compositions of the present invention are employed in an amount sufficient to give a corrosion rate less than or equal to about 0.015 lb/ft²/day. The corrosion inhibitor composition may be dissolved or dispersed in the cleaning solution prior to contacting the cleaning solution and the metal to be cleaned.

The following examples illustrate the invention, but are not limiting thereof. All parts and percentages are given by weight unless otherwise stated.

### EXAMPLE 1

The object of this experiment was to test the removal of greasy soil with engine cleaner formulations. A mixture of 7.5 g vegetable oil (Crisco™ oil, The J. M. Smucker Co, Orville, Ohio) and 0.1 g carbon black was heated until liquefied. 0.5 g of the heated mixture was spread onto a metal coupon (steel coupon of 0.032″×1″×3″ dimensions available from Q-Panel Lab Products, Cleveland Ohio) and allowed to dry. The metal coupon was then partially submerged in 50 ml of a formulation containing morpholine or didecyldimethyl ammonium carbonate/bicarbonate (DDACB), as detailed in Table 1 below. After 1 hour, the metal coupon was removed from the formulation, and rinsed with water. A visual assessment was performed as to how much of the greasy soil was removed from the submerged portion of the metal coupon. The results are set forth in Table 1.

As shown in Table 1, replacement of morpholine by didecyldimethyl ammonium carbonate in the microemulsion results in significant improvement in both formulation stability and cleaning ability. Formulations A and B, both containing didecyldimethyl ammonium carbonate, resulted in removal of 100% of the greasy soil from the metal coupon, and maintained one phase, whereas formulations C and D, both of which contained morpholine and no didecyldimethyl ammonium carbonate, resulted in only 20% greasy soil removal and phase separated into two opaque phases.

TABLE 1

| | Formulation A | Formulation B | Formulation C | Formulation D |
|---|---|---|---|---|
| Ingredient | (% wt/wt) | (% wt/wt) | (% wt/wt) | (% wt/wt) |
| Aromatic 200 ™ | 6.0 | 6.0 | 6.0 | 6.0 |
| Exxate 700 ™ | 6.0 | 6.0 | 6.0 | 6.0 |
| Dowanol DpnB ™ | 20.0 | 20.0 | 20.0 | 20.0 |
| DDACB (50%) | 12.0 | 15.0 | — | — |
| Neodol 91-6 ™ | — | — | 7.5 | 7.5 |
| Morpholine | — | — | — | 7.5 |
| Deionized Water | 56.0 | 53.0 | 60.5 | 53.0 |
| TOTAL | 100.0 | 100.0 | 100.0 | 100.0 |
| Appearance | One phase | One phase | Two phases | Two phases |
| | Slightly hazy | Clear | Opaque | Opaque |
| Greasy Soil | 100% | 100% | 20% | 20% |
| Removal | | | | |

Aromatic 200™ is a mixture of aromatic hydrocarbons available from ExxonMobil Chemical of Houston, Tex.

Exxate 700™ is oxo-heptyl acetate available from ExxonMobil Chemical of Houston, Tex.

Dowanol DpnB™ is dipropylene n-butyl ether available from Dow Chemical of Midland, Mich.

Neodol 91-6™ is a mixture of C9-11 alcohols with an average of six moles of ethoxylation available from Shell Chemicals of Houston, Tex.

### EXAMPLE 2

Cold rolled steel coupons (steel coupons of 0.032″×1″×3″ dimensions (Q-Panel Lab Products, Cleveland Ohio)) were fully exposed to either deionized water or tap water, and to either deionized water containing 100 or 1000 ppm of didecyldimethyl ammonium carbonate/bicarbonate (DDACB) mixture or tap water containing 100 or 1000 ppm of didecyldimethyl ammonium carbonate/bicarbonate mixture for one week. The coupons were then removed, rinsed with either deionized or tap water and brushed lightly with a soft nylon brush. The coupons were then dried under a stream of nitrogen and weighed. The results are set forth in Table 2 below. Differences in weight are expressed as (−) for weight loss, or (+) for weight gain.

TABLE 2

| | | | Wt (g) | Wt (g) | Wt. |
|---|---|---|---|---|---|
| Sample | # | pH | (before) | (after) | change |
| DI water | 1 | 8.6 | 12.6248 | 12.6193 | −0.044 |
| DI water + 100 ppm | 2 | 9.1 | 12.6161 | 12.6112 | −0.039 |
| DDACB | | | | | |
| DI water + 1000 ppm | 3 | 8.3 | 12.5870 | 12.6873 | +0.002 |
| DDACB | | | | | |
| Tap water | 4 | 7.1 | 12.6807 | 12.6735 | −0.057 |
| Tap water + 100 ppm | 5 | 7.2 | 12.7034 | 12.6969 | −0.0051 |
| DDACB | | | | | |
| Tap water + 1000 ppm | 6 | 7.5 | 12.6561 | 12.6564 | +0.002 |
| DDACB | | | | | |
| DI water | 7 | 12.6521 | 12.6463 | −0.046 | −0.045 |
| DI water + 100 ppm | 8 | 12.5611 | 12.5555 | −0.045 | −0.042 |
| DDACB | | | | | |
| Tap water | 9 | 12.5824 | 12.5824 | 0.000 | +0.001 |
| Tap water + 100 ppm | 10 | 12.5739 | 12.5667 | −0.057 | −0.057 |
| DDACB | | | | | |
| Tap water + 1000 ppm | 11 | 12.5835 | 12.577 | +0.052 | +0.051 |
| DDACB | | | | | |
| DI water | 12 | 12.5933 | 12.5935 | +0.002 | +0.002 |

As shown in Table 2, solutions containing 1000 ppm of didecyldimethyl ammonium carbonate/bicarbonate did not degrade after 1 week, as evidenced by no loss in weight of the metal coupon. After 1 week, test solutions 1, 2, 4, 5, 7, 8, 10, and 11 became brown and showed sediment on the bottom of the glass jar. No sediment was observed for samples 3, 6, 9, and 12. Corrosion was observed on the cold rolled steel coupon exposed to deionized water after one hour, while no corrosion was observed on the coupon exposed to deionized water containing 1000 ppm of the didecyldimethyl ammonium carbonate/bicarbonate after one week.

### EXAMPLE 3

Deionized water (58.2% w/w), surfactant (octyl dimethyl amine oxide (40% active), FMB-A08®, Lonza, Inc., Fair Lawn, N.J.) (8.0% w/w) and a 50% aqueous solution of a quaternary compound (didecyldimethyl ammonium chloride (DDAC), or didecyldimethyl ammonium carbonate/bicarbonate mixture (DDACB)) (33.8% w/w) were mixed together.

A 1:256 dilution of the mixture (660 ppm active quaternary ammonium compound) in water was used to assess the corrosion inhibition properties of DDAC and DDACB. Cold rolled steel plates (steel coupons of 0.032″×1″×3″ dimensions (Q-Panel Lab Products, Cleveland Ohio)) were immersed in each of the aqueous solutions and monitored, at room temperature, for a period of nine months.

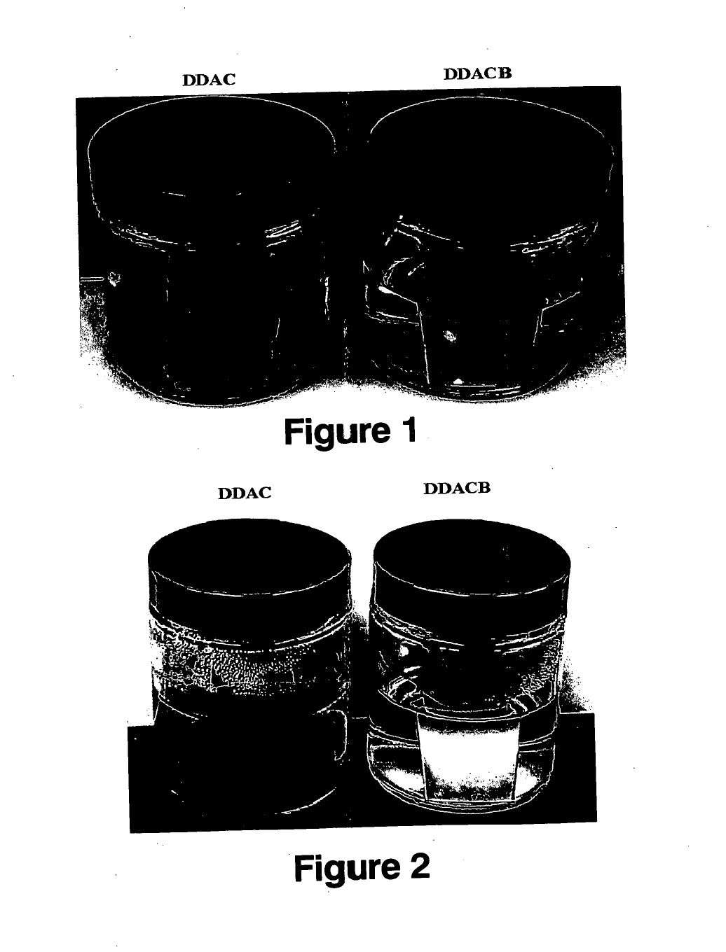

FIGS. 1 and 2 are pictures of the plates after standing at room temperature in the aqueous solutions for 90 minutes and 30 days, respectively. As can be seen, the plate in the DDAC solution has started to corrode, after only 90 minutes, and is badly corroded after 30 days. In contrast, the plate in DDACB shows no corrosion whatsoever, even after 30 days.

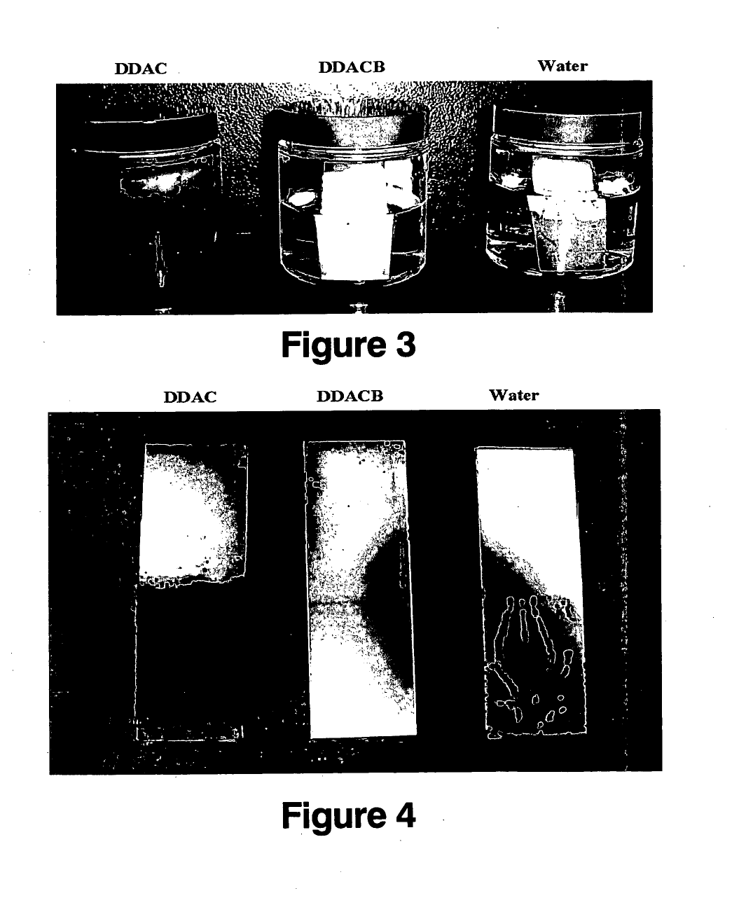

FIGS. 3 and 4 are pictures of the plates after standing at room temperature in the aqueous solutions for a total of 9 months. As can be seen, the plate in the DDACB solution shows no corrosion, whilst the plate in the DDAC solution is fully corroded. For comparison purposes, a piece of identical cold rolled steel, soaked in deionized (DI) water containing no quaternary ammonium compound is also shown. Even after only 5 hours in DI water, the plate shows some signs of corrosion.

All references cited and discussed herein are incorporated by reference in their entirety and to the same extent as if each reference was individually incorporated by reference. In the case of conflicting terminology, the present disclosure shall control.

1. A method for inhibiting corrosion of a metal substrate comprising the step of contacting the substrate with a corrosion inhibiting effective amount of a composition comprising:
(a) at least one quaternary ammonium compound selected from a quaternary ammonium carbonate, a quaternary ammonium bicarbonate, and mixtures thereof; and
(b) optionally, a solvent.

2. The method of claim 1, wherein the quaternary ammonium carbonate has the formula: 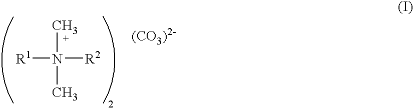
wherein R¹ is a C₁-C₂₀ alkyl or aryl-substituted C₁-C₂₀ alkyl group, and R² is a C₁-C₂₀ alkyl or aryl-substituted C₁-C₂₀ alkyl group.

3. The method of claim 1, wherein the quaternary ammonium bicarbonate has the formula: 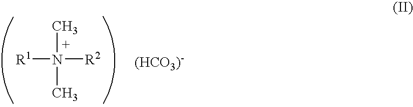
wherein R¹ is a C₁-C₂₀ alkyl or aryl-substituted C₁-C₂₀ oalkyl group, and R² is a C₁-C₂₀ alkyl or aryl-substituted C₁-C₂₀ alkyl group.

4. The method of claim 2, wherein R¹ and R² are the same C₁-C₂₀ alkyl group.

5. The method of claim 2, wherein R¹ and R² are C₁₀ alkyl groups.

6. The method of claim 5, wherein R¹ and R² are n-C₁₀ alkyl groups.

7. The method of claim 2, wherein one of R¹ or R² is methyl.

8. The method of claim 7, wherein R¹ and R² are methyl.

9. The method of claim 2, wherein one of R¹ and R² is benzyl or ethylbenzyl.

10. The method of claim 1, wherein the quaternary ammonium carbonate is didecyldimethyl ammonium carbonate and the quaternary ammonium bicarbonate is didecyldimethyl ammonium bicarbonate.

11. The method of claim 1, wherein the composition further comprises:
(c) a surfactant selected from amine oxides, linear alcohol ethoxylates, secondary alcohol ethoxylates, ethoxylate ethers, betamines, and mixtures thereof.

12. The method of claim 11, wherein the surfactant is nonylphenol ethoxylate.

13. The method of claim 1, wherein the metal substrate is in an oil environment.

14. The method of claim 13, wherein the oil environment comprises a petroleum distillate.

15. The method of claim 14, wherein the petroleum distillate is selected from kerosene, white spirit, hydrocarbon fractions, and mixtures thereof.

16. The method of claim 1, wherein the composition further comprises
(d) a builder;
(e) a colorant;
(f) a perfume;
(g) a fragrance; or
(h) a combination thereof.

17. The method of claim 1, wherein the metal substrate is selected from steel, cast iron, aluminum, metal alloys and combinations thereof.

18. An anti-corrosive coating for a metal substrate comprising
(a) at least one quaternary ammonium carbonate, quaternary ammonium bicarbonate, or a mixture thereof; and
(b) a coating material.

19. The anti-corrosive coating of claim 18, wherein the quaternary ammonium carbonate, bicarbonate, or mixture thereof is dispersed in the coating material.

20. An aqueous solution comprising a corrosion inhibiting effective amount of at least one quaternary ammonium carbonate, quaternary ammonium bicarbonate, or a mixture thereof.

21. The aqueous solution of claim 20, wherein the aqueous solution is a cleaning solution.
